(19) United States
(12) Patent Application Publication
(10) Pub. No.: US 2007/0086395 A1
(43) Pub. Date: Apr. 19, 2007

(54) Wireless paging apparatus, systems and methods

(76) Inventors: Sanjay Bakshi, Beaverton, OR (US); Sameer Pareek, Portland, OR (US); Bala Rajagopalan, Beaverton, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/251,066

(22) Filed: Oct. 14, 2005

(51) Int. Cl. H04Q 7/24

(52) U.S. Cl. 370/338; 370/352

(57) ABSTRACT

Embodiments of wireless paging apparatus, systems, and methods are described generally herein. Other embodiments may be described and claimed.

### RELATED APPLICATION

This application is related to U.S. application Ser. No. 11/208,427 filed on Aug. 19, 2005.

### TECHNICAL FIELD

Various embodiments described herein relate to digital communications generally, including apparatus, systems, and methods used to localize a mobile node and to direct a packet stream thereto.

### BACKGROUND INFORMATION

Emerging wireless network technologies may include wireless networks designed with a packet-switched architecture. Such network may be referred to herein as a wireless packet-switched network (WPSN). A mobile wireless device (“mobile node”) operating within a WPSN may be capable of communicating a variety of media, including perhaps data, voice, and video, among others. Internet protocol (IP) datagrams may be utilized.

The WPSN may support mobility operation. That is, the mobile node may operate in an area of radio-frequency (RF) coverage associated with a first base station to which the mobile node has attached via a wireless protocol. The mobile node may engage in a packet exchange session (e.g., a transfer control protocol session) with another network node. The mobile node may then move from the area of RF coverage associated with the first base station to an area of RF coverage associated with a second base station without disconnecting the packet exchange session.

The mobile node may update the network with its current location by sending a registration message when it transitions from the first base station to the second base station. This may result in a large number of bandwidth-consuming control messages in a WPSN supporting a large population of mobile nodes. The problem may be compounded as a number of base stations per unit area of RF coverage increases. Since data transmission may be bursty in nature, the mobile node may be required to send location updates as a user moves around in the WPSN even when no packet exchange session is in process. The mobile node may experience reduced operating time between battery charges as a result.

### BRIEF DESCRIPTION OF THE DRAWINGS

FIG. 1 is a block diagram of an apparatus and a representative system according to various embodiments of the invention.

FIG. 2 is a flow diagram illustrating several methods according to various embodiments of the invention.

FIGS. 3A and 3B are flow diagrams illustrating several methods according to various embodiments of the invention.

FIG. 4 is a block diagram of an article according to various embodiments of the invention.

### DETAILED DESCRIPTION

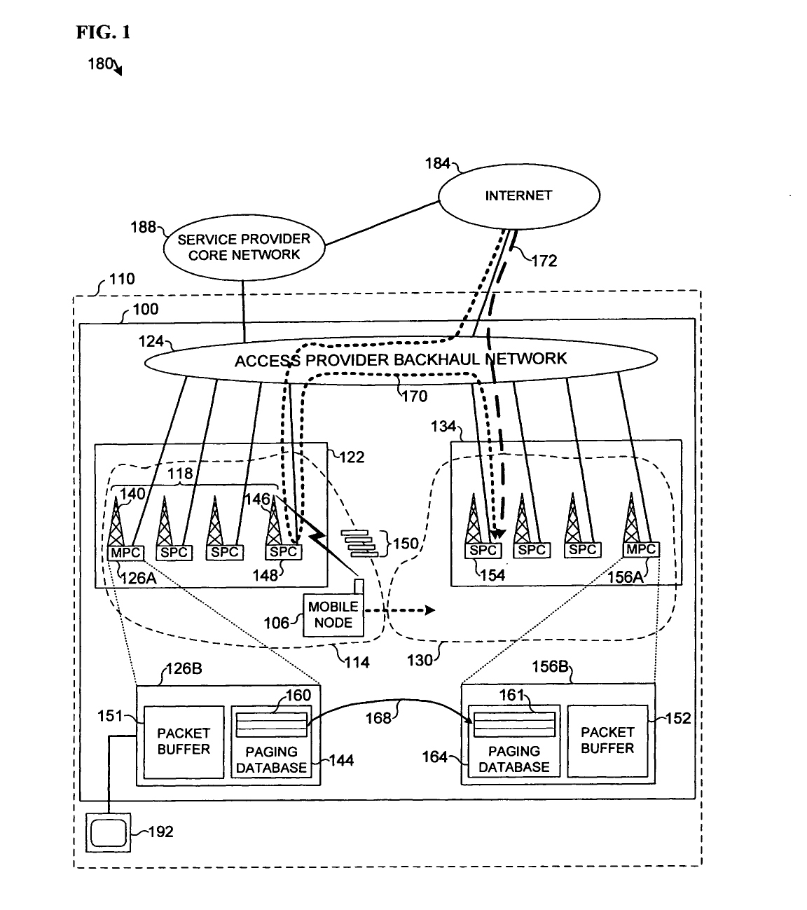

FIG. 1 comprises a block diagram of an apparatus 100 and a system 180 according to various embodiments of the invention. Some embodiments may decrease a frequency of location updates from a mobile node 106 operating in a WPSN 110. The frequency of location updates may be decreased while the mobile node 106 moves within an area of RF coverage 114 associated with one or more base stations 118. The base stations 118 may be associated with a portion of the WPSN 110 referred to herein as a paging group (e.g., first paging group 122). The base stations 118 may implement media access control and radio physical layer functions and may operate to create the area of RF coverage 114.

IP traffic from base stations associated with multiple paging groups may be aggregated in an access provider backhaul network, referred to hereinafter as the “backhaul network 124.” The backhaul network 124 may comprise an IP network constructed using standard IP packet routers and switches. The backhaul network 124 may be connected to an Internet 184. The backhaul network 124 may also be aggregated with other backhaul networks by a service provider core network, referred to hereinafter the “core network 188.” The core network 188 may provide the WPSN 110 with connectivity to the Internet.

In some embodiments herein, a paging controller may be collocated with an individual base station within a paging group. For purposes of this application, “collocated” means located within or adjacent to a facility comprising the base station. The paging controller might, for example, be located within a building housing the base station, or might be attached to a base station antenna complex. One paging controller may be selected from the resulting set of paging controllers associated with a particular paging group to comprise a master paging controller (MPC). All other paging controllers collocated with the respective base stations within the paging group are denominated as slave paging controllers (SPCs). An SPC may buffer packets for the mobile node and may update the MPC with a location of the mobile node while the mobile node operates in an idle mode. The MPC may instruct the base stations within a paging group to broadcast paging messages to the mobile node.

Thus, for example, a first MPC 126A and 126B may cause a paging advertisement directed to the mobile node 106 to be broadcast by the base station(s) 118, wherein the base station(s) 118 are associated with the first paging group 122. The paging advertisement may query the mobile node 106 for its location and may advise the mobile node 106 of pending data.

Limiting a transmission of the paging advertisement to a paging group may conserve spectrum resources. The WPSN 110 may be divided into paging groups based upon various system factors. These may include base station density relative to expected mobile node traffic, among others. The mobile node 106 may thus update the WPSN 110 when it moves from the first area of RF coverage 114 associated with the first paging group 122 to a second area of RF coverage 130 associated with a second paging group 134. The WPSN 110 may localize the mobile node 106 to a particular paging group without tracking movement of the mobile node 106 from one base station to another within the particular paging group. Some embodiments may support adjustment of a granularity of paging localization using this architecture.

A paging group (e.g., the paging group 122 or the paging group 134) may thus provide a contiguous coverage region within which the mobile node 106 need not be required to transmit in an uplink direction, but can be paged in the downlink direction if necessary. For example, the mobile node 106 may be paged in the downlink direction so that the paging group may forward pending traffic to the mobile node 106 or perform network management service transactions with the mobile node 106. Some embodiments of the invention may conserve scarce power resources in the mobile node 106 while conserving spectral resources associated with the WPSN 110 using disclosed architectures.

Example embodiments may be described wherein a separate MPC may be associated with each of several paging groups. However, it should be noted that in some embodiments an MPC may control paging in more than one paging group.

The apparatus 100 may thus include the first MPC 126A collocated with an MPC base station 140. The MPC base station 140 may be associated with the first paging group 122 within the WPSN 110. The first MPC 126A may localize the mobile node 106 to the first paging group 122, and may control packet forwarding to the mobile node 106. The mobile node 106 may be adapted to operate according to a power management protocol within the first RF coverage area 114 corresponding to the first paging group 122. A first paging database 144 may be coupled to the first MPC 126B to store paging information associated with the mobile node 106.

A paging base station 146 may establish an RF association with the mobile node 106. The paging base station 146 may also transmit paging advertisements to the mobile node 106. The paging base station 146 may receive location updates from the mobile node 106 while the mobile node 106 moves within the first RF coverage area 114 associated with the first paging group 122. The location updates may be responsive to the paging advertisements.

The apparatus 100 may also include a first paging controller 148 collocated with the paging base station 146. The first paging controller 148 may comprise an MPC. Alternatively, the first paging controller 148 may comprise an SPC to update the first MPC with information pertaining to the RF association. The first paging controller 148 may buffer packets 150 directed to the mobile node 106 while the mobile node 106 is in an idle state. Packet buffers 151 and 152 may be associated with MPCs 126B and 156B respectively. Similar packet buffers may be associated with an SPC. The first paging controller 148 may also receive location updates from the paging base station 146.

An SPC may be coupled to the first MPC 126A using the backhaul network 124 to forward packets between the SPC and the first MPC 126A. The backhaul network 124 may be coupled to the Internet 184 to transfer packets between the mobile node 106 and the Internet 184. The backhaul network 124 may also be coupled to the core network 188, as previously mentioned. The core network 188 may in turn be connected to the Internet 184 to transfer packets between the mobile node and the Internet 184.

The apparatus 100 may also include a second paging controller 154 associated with the second paging group 134. The second paging controller 154 may receive a location update from the mobile node 106 after the mobile node 106 moves from the first RF coverage area 114 to the second RF coverage area 130 associated with the second paging group 134. A second MPC 156A and 156B may be associated with the second paging group 134 to receive a notification from the second paging controller 154 that the mobile node 106 has moved into the second RF coverage area 130.

The second MPC 156A may also notify the first MPC 126A that the mobile node 106 has moved into the second RF coverage area 130. One or more idle-mode retention parameters, generally shown as 160 and 161, may be associated with the mobile node 106. The idle-mode retention parameter(s) 160 and 161 may comprise a paging controller identification, a paging group identification, or both. The idle-mode retention parameter(s) 160 and 161 may be transferred from the first paging database 144 maintained by the first MPC 126B to a second paging database 164 maintained by the second MPC 156. A transfer 168 may occur when the mobile node 106 moves from the first RF coverage area 114 to the second RF coverage area 130.

The second MPC 156A may cause any packets buffered by the first paging controller 148 to be forwarded to the second paging controller 154. The second MPC 156A may also establish a forwarding route (e.g., the route 170 or the route 172) through the network to the second paging controller 154. Packets received by the WPSN 110 to deliver to the mobile node 106 may be forwarded to the second paging controller 154 via the forwarding routes 170 or 172.

In another embodiment, a system 180 may include one or more of the apparatus 100, as previously described. The system 180 may also include a display 192 coupled to the first MPC 126B to display configuration information associated with the first MPC. The display 192 may comprise a cathode ray tube display or a solid-state display such as a liquid crystal display, a plasma display, or a light-emitting diode display, among other types.

Any of the components previously described can be implemented in a number of ways, including embodiments in software. Thus, the apparatus 100; mobile node 106; wireless packet-switched network (WPSN) 110; areas of radio-frequency (RF) coverage 114, 130; base stations 118, 140, 146; paging groups 122, 134; backhaul network 124; paging controllers 126A, 126B, 148, 154, 156A, 156B; paging databases 144, 164; packets 150; packet buffers 151, 152; idle-mode retention parameters 160, 161; transfer 168; routes 170, 172; system 180; Internet 184; core network 188; and display 192 may all be characterized as “modules” herein.

The modules may include hardware circuitry, single or multi-processor circuits, memory circuits, software program modules and objects, firmware, and combinations thereof, as desired by the architect of the apparatus 100 and system 180 and as appropriate for particular implementations of various embodiments.

It should also be understood that the apparatus and systems of various embodiments can be used in applications other than controlling paging broadcasts within a paging group using a master paging controller collocated with a base station. Thus, various embodiments of the invention are not to be so limited. The illustrations of apparatus 100 and system 180 are intended to provide a general understanding of the structure of various embodiments. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, and others. Some embodiments may include a number of methods.

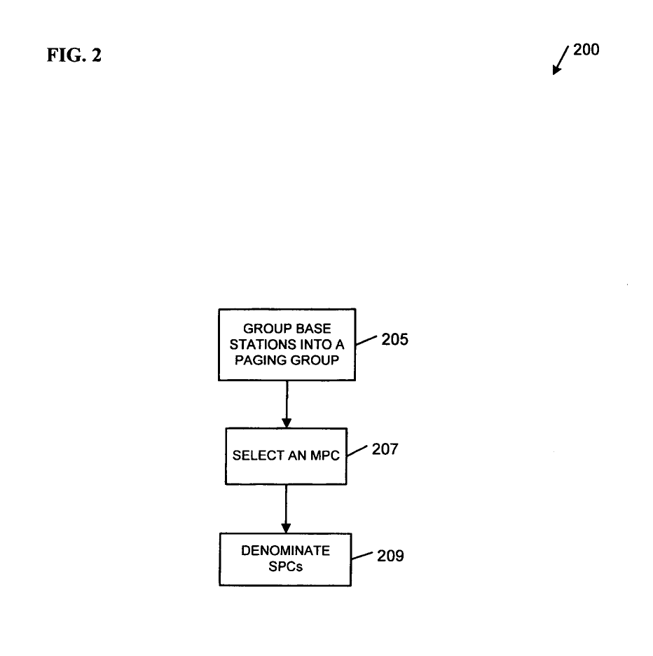

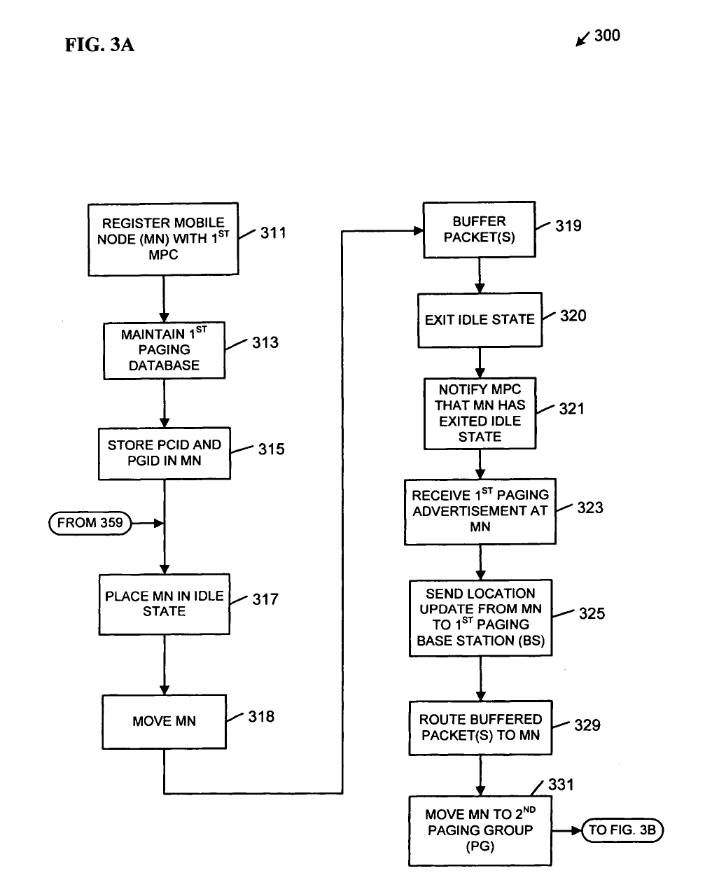

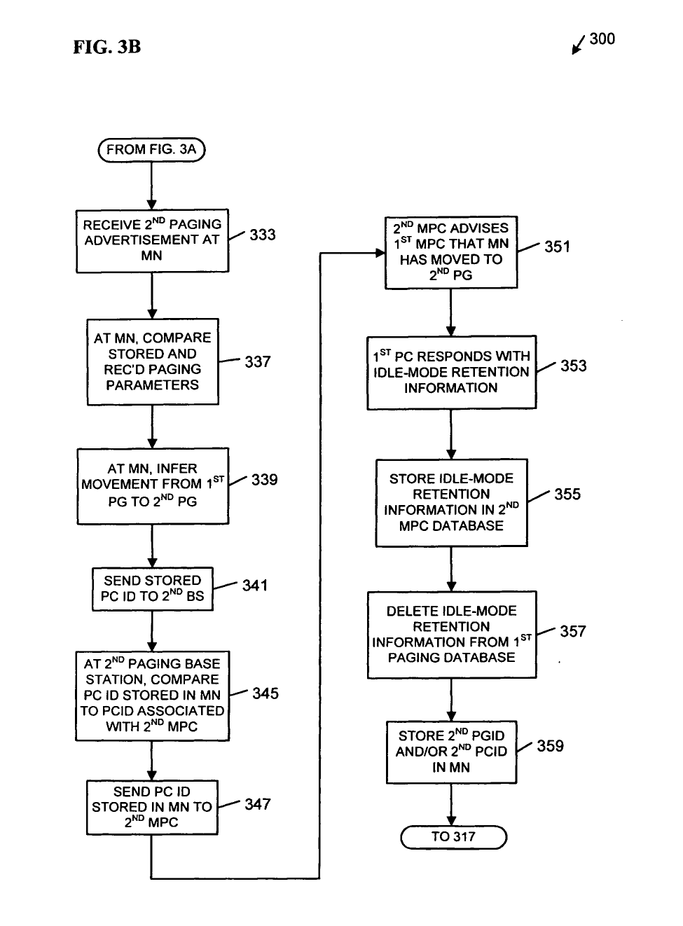

FIGS. 2, 3A, and 3B are flow diagrams illustrating several methods according to various embodiments of the invention. A method 200 may include initializing a paging controller configuration within a WPSN. The method 200 may begin at block 205 with grouping a plurality of base stations including the MPC base station into a paging group. Referring back to FIG. 1, for example, the base stations 118 including the MPC base station 140 may be grouped into the paging group 122. A paging controller may be collocated with each base station in the paging group. The method 200 may continue at block 207 with selecting one of the paging controllers as the first MPC. Paging controllers not selected to be the first MPC may be denominated as SPCs, at block 209. The paging controller 148 of FIG. 1 may not be selected as the MPC. Thus, the paging controller 148 may be an SPC.

A method 300 may include localizing a mobile node to a first paging group within the WPSN. The mobile node may be localized using a first MPC collocated with an MPC base station associated with the first paging group. The MPC may also establish a packet forwarding route through the network to deliver one or more packets to the mobile node. Packet forwarding routes may include the route 170 or the route 172 of FIG. 1.

The method 300 may begin at block 311 with registering the mobile node with the first MPC before the mobile node (MN) enters an idle state. The method 300 may further include maintaining a first paging database using the first MPC, at block 313. The first paging database may include idle-mode retention information associated with the mobile node to be maintained while the mobile node is in an idle state. The idle-mode retention information may comprise a paging controller identification (PCID) associated with the first MPC, a paging group identification (PGID) associated with the first paging group, or both.

The method 300 may include storing the PCID, the PGID, or both in the mobile node, at block 315. The method 300 may also include placing the mobile node in the idle state for an idle period, at block 317. The mobile node may then be moved within an area of RF coverage associated with the first paging group, at block 318. The area of RF coverage may include, for example, the area 114 of FIG. 1. The mobile node may be moved without performing a location update unless the mobile node receives a paging advertisement.

The method 300 may include buffering one or more packets in a paging controller, at block 319. The paging controller used to buffer the packet(s) may be associated with a paging base station where the mobile node last entered the idle state. Alternatively, the packet(s) may be buffered in a paging controller associated with a paging base station where the mobile node last performed a location update. The first paging controller 148 of FIG. 1 may comprise an example of either or both of these concepts.

The method 300 may continue at block 320 with exiting the idle state following the idle period. The first MPC may be notified that the mobile node has exited the idle state, at block 321. The method 300 may include receiving a first paging advertisement at the mobile node from a first paging base station upon exiting the idle state, at block 323. The first paging advertisement may be triggered by the first MPC and may include the PCID associated with the first MPC. The method 300 may continue at block 325 with sending a location update message from the mobile node to the first paging base station. The message may be sent upon exiting the idle state, in response to the first paging advertisement.

The method 300 may further include routing the packet(s) buffered in the paging controller to the mobile node, at block 329. The MPC located within the paging group associated with the paging base station where the mobile node last exited the idle state may be used to establish the routing.

The method 300 may continue at block 331 with moving the mobile node from a first area of RF coverage associated with the first paging group to a second area of RF coverage associated with a second paging group. For example, the mobile node may be moved to the second area of RF coverage 130 associated with the second paging group 134 of FIG. 1. A second paging advertisement may be received at the mobile node from a second paging base station, at block 333. The second paging base station (e.g., a base station associated with the second paging controller 154 of FIG. 1) may be located in the second paging group. The second paging advertisement may include a PCID associated with a second MPC (e.g., the second MPC 156A of FIG. 1) associated with the second paging group. The mobile node may compare the PCID associated with the second MPC to a PCID stored in the mobile node, at block 337. From the comparison of the two PCIDs, the mobile node may infer that the mobile node has moved from the first area of RF coverage to the second area of RF coverage, at block 339.

The method 300 may further include transmitting the PCID stored in the mobile node to the second paging base station, at block 341. The second paging base station may compare the PCID stored in the mobile node to the PCID associated with the second MPC, at block 345. The second paging base station may recognize that the PCID stored in the mobile node and the PCID associated with the second MPC are different. The second paging base station may consequently send the PCID stored in the mobile node from the second paging base station to the second MPC, at block 347.

The method 300 may also include sending a message from the second MPC to the first MPC to advise the first MPC that the mobile node has moved to the second paging group, at block 351. The second MPC may receive a response from the first MPC including the idle-mode retention information associated with the mobile node, at block 353. Messages communicated between the first MPC and the second MPC may traverse a backhaul network (e.g., the backhaul network 124 of FIG. 1). The backhaul network may couple a plurality of paging controllers associated with a plurality of base stations to a core network. The first and second MPCs and one or more paging controllers used to buffer packets may be included in the plurality of paging controllers.

The second MPC may store the idle-mode retention information in a second paging database (e.g., the second paging database 164 of FIG. 1) associated with the second MPC, at block 355. The first MPC may then delete the idle-mode retention information from its paging database, perhaps upon receiving a confirmation that the information has been stored in the second paging database, at block 357. The method 300 may include updating and storing the PCID associated with the second MPC, a PGID associated with the second paging group, or both in the mobile node, at block 359. The method 300 may loop back to block 317 as the mobile node again enters the idle state.

The first and second MPCs may perform other operations, including those defined by a mobile-Internet protocol (mobile-IP), an Institute of Electrical and Electronic Engineers (IEEE) 802.16e protocol, or both. Additional information regarding mobile-IP may be found in Internet Engineering Task Force (IETF) Request for Comments (RFC) 3344 “IP Mobility Support for IPv4” (August 2002) and related RFCs. Additional information regarding IEEE 802.16e, a standard not yet finalized at the time of this application, may be found at the IEEE 802.16 Task Group e (Mobile WirelessMAN®) website, http://www.ieee802.org/16/tge/. Although the above examples are described with respect to particular wireless communication protocols, the methods, apparatus, and systems described herein may be implemented in accordance with other suitable wireless communication technologies/protocols such as variations and/or evolutions of the IEEE 802.16 family of standards.

It may be possible to execute the activities described herein in an order other than the order described. And, various activities described with respect to the methods identified herein can be executed in repetitive, serial, or parallel fashion.

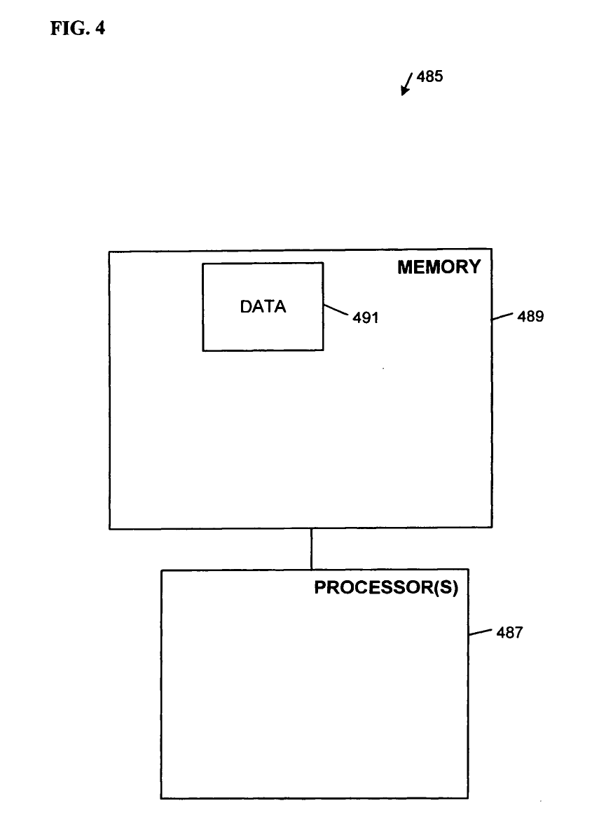

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 4 below.

FIG. 4 is a block diagram of an article 485 according to various embodiments of the invention. Examples of such embodiments may comprise a computer, a memory system, a magnetic or optical disk, some other storage device, or any type of electronic device or system. The article 485 may include one or more processor(s) 487 coupled to a machine-accessible medium such as a memory 489 (e.g., a memory including electrical, optical, or electromagnetic elements). The medium may contain associated information 491 (e.g., computer program instructions, data, or both) which, when accessed, results in a machine (e.g., the processor(s) 487) performing the activities previously described.

Implementing the apparatus, systems, and methods disclosed herein may provide a contiguous paging region within a WPSN. A mobile node may be localized within the WPSN to a paging group, and a pending packet stream may be delivered across the WPSN to the mobile node. Disclosed architectures may conserve mobile node power and system spectral resources.

Although the inventive concept may include embodiments described in the exemplary context of an 802.xx implementation (e.g., 802.11, 802.11a, 802.11g, 802.11n, 802.11 HT, 802.16, etc.), the claims are not so limited. Embodiments of the present invention may be implemented as part of any wired or wireless system Examples may also include embodiments comprising multi-carrier wireless communication channels (e.g., OFDM, DMT, etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a first master paging controller (MPC) collocated with an MPC base station, the MPC base station associated with a first paging group within a wireless packet-switched network (WPSN), the first MPC to localize a mobile node to the first paging group and to control packet forwarding to the mobile node; and
a paging database coupled to the first MPC to store paging information associated with the mobile node.

2. The apparatus of claim 1, wherein the mobile node is adapted to operate according to a power management protocol within a first radio-frequency (RF) coverage area corresponding to the first paging group.

3. The apparatus of claim 1, further including:
a first paging controller collocated with a paging base station, the paging base station to establish a radio-frequency (RF) association with the mobile node, to transmit paging advertisements to the mobile node, and to receive location updates from the mobile node while the mobile node moves within a first RF coverage area associated with the first paging group, the first paging controller to buffer packets directed to the mobile node while the mobile node is in an idle state and to receive the location updates from the paging base station.

4. The apparatus of claim 3, wherein the first paging controller comprises an MPC.

5. The apparatus of claim 3, wherein the first paging controller comprises a slave paging controller (SPC) to update the first MPC with information pertaining to the RF association.

6. The apparatus of claim 5, wherein the SPC is coupled to the first MPC using a backhaul network to forward packets between the SPC and the first MPC.

7. The apparatus of claim 6, wherein the backhaul network is coupled to an Internet to transfer packets between the mobile node and the Internet.

8. The apparatus of claim 6, wherein the backhaul network is coupled to a core network, the core network in turn connected to the Internet to transfer packets between the mobile node and the Internet.

9. The apparatus of claim 3, further including:
a second paging controller associated with a second paging group to receive a location update from the mobile node after the mobile node moves from the first RF coverage area to a second RF coverage area associated with the second paging group.

10. The apparatus of claim 9, further including:
a second MPC associated with the second paging group to receive a notification from the second paging controller that the mobile node has moved into the second RF coverage area, to notify the first MPC that the mobile node has moved into the second RF coverage area, to cause any packets buffered by the first paging controller to be forwarded to the second paging controller, and to establish a forwarding route through the network to the second paging controller.

11. A system, including:
a first master paging controller (MPC) collocated with an MPC base station, the MPC base station associated with a first paging group within a wireless packet-switched network (WPSN), the first MPC to localize a mobile node to the first paging group and to control packet forwarding to the mobile node;
a paging database coupled to the first MPC to store paging information associated with the mobile node; and
a display coupled to the first MPC to display configuration information associated with the first MPC.

12. The system of claim 11, wherein the first MPC is communicatively coupled to a first paging controller collocated with a paging base station, the paging base station to establish a radio-frequency (RF) association with the mobile node, to transmit paging advertisements to the mobile node, and to receive location updates from the mobile node while the mobile node moves within a first RF coverage area associated with the first paging group, the first paging controller to buffer packets directed to the mobile node while the mobile node is in an idle state and to receive the location updates from the paging base station.

13. The system of claim 12, wherein the first MPC is communicatively coupled to a second MPC associated with the second paging group, the second MPC to receive a notification from a second paging controller that the mobile node has moved into a second RF coverage area, to notify the first MPC that the mobile node has moved into the second RF coverage area, to cause any packets buffered by the first paging controller to be forwarded to the second paging controller, and to establish a forwarding route through the network to the second paging controller.

14. A method, including:
localizing a mobile node to a first paging group within a wireless packet-switched network (WPSN) using a first master paging controller (MPC) collocated with an MPC base station associated with the first paging group; and
establishing a packet forwarding route through the network to deliver a packet to the mobile node.

15. The method of claim 14, further including:
grouping a plurality of base stations including the MPC base station into a first paging group, wherein a paging controller is collocated with each base station;
selecting one of the paging controllers as the first MPC; and
denominating the paging controllers not selected to be the first MPC as slave paging controllers.

16. The method of claim 14, further including:
maintaining a first paging database using the first MPC, wherein the first paging database includes idle-mode retention information associated with the mobile node, the idle-mode retention information to be maintained while the mobile node is in an idle state; and
registering the mobile node with the first MPC before the mobile node enters the idle state.

17. The method of claim 16, wherein the idle-mode retention information comprises at least one of a paging controller identification (PCID) associated with the first MPC and a paging group identification (PGID) associated with the first paging group.

18. The method of claim 17, further including:
storing the PCID and the PGID in the mobile node;
placing the mobile node in the idle state for an idle period;
exiting the idle state following the idle period;
notifying the first MPC that the mobile node has exited the idle state; and
receiving a first paging advertisement at the mobile node from a first paging base station upon exiting the idle state, wherein the first paging advertisement is triggered by the first MPC and includes the PCID associated with the first MPC.

19. The method of claim 18, further including:
buffering a packet in a paging controller associated with at least one of a paging base station where the mobile node last entered the idle state or a paging controller associated with a paging base station where the mobile node last performed a location update.

20. The method of claim 19, further including:
upon exiting the idle state, sending a location update message from the mobile node to the first paging base station in response to the first paging advertisement.

21. The method of claim 20, further including:
routing the packet buffered in the paging controller to the mobile node using an MPC to establish the routing, the MPC located within a paging group associated with a paging base station where the mobile node last exited the idle state.

22. The method of claim 18, further including:
moving the mobile node within an area of radio-frequency coverage associated with the first paging group without performing a location update unless the mobile node receives a paging advertisement.

23. The method of claim 16, further including:
moving the mobile node from a first area of radio-frequency (RF) coverage associated with the first paging group to a second area of RF coverage associated with a second paging group;
receiving a second paging advertisement at the mobile node from a second paging base station located in the second paging group, the second paging advertisement including a PCID associated with a second MPC, wherein the second MPC is associated with the second paging group;
at the mobile node, comparing the PCID associated with the second MPC to a PCID stored in the mobile node; and
at the mobile node, inferring from the comparison of the two PCIDs that the mobile node has moved from the first area of RF coverage to the second area of RF coverage.

24. The method of claim 23, further including:
transmitting the PCID stored in the mobile node to the second paging base station;
at the second paging base station, comparing the PCID stored in the mobile node to the PCID associated with the second MPC; and
upon recognizing that the PCID stored in the mobile node and the PCID associated with the second MPC are different, sending the PCID stored in the mobile node from the second paging base station to the second MPC.

25. The method of claim 24, further including:
sending a message from the second MPC to the first MPC to advise the first MPC that the mobile node has moved to the second paging group;
receiving a response at the second MPC from the first MPC including the idle-mode retention information;
storing the idle-mode retention information in a second paging database associated with the second MPC;
deleting the idle-mode retention information from the first paging database associated with the first MPC; and
updating and storing in the mobile node at least one of the PCID associated with the second MPC and a PGID associated with the second paging group.

26. The method of claim 25, wherein messages communicated between the first MPC and the second MPC traverse a backhaul network, and wherein the backhaul network couples a plurality of paging controllers associated with a plurality of base stations to a core network.

27. An article including a machine-accessible medium having associated information, wherein the information, when accessed, results in a machine performing:
localizing a mobile node to a first paging group within a wireless packet-switched network using a first master paging controller (MPC) collocated with an MPC base station associated with the first paging group; and
establishing a packet forwarding route through the network to deliver a packet to the mobile node.

28. The article of claim 27, wherein the information, when accessed, results in a machine performing:
maintaining a first paging database using the first MPC, wherein the first paging database includes idle-mode retention information associated with the mobile node, the idle-mode retention information to be maintained while the mobile node is in an idle state; and
registering the mobile node with the first MPC before the mobile node enters the idle state.

29. The article of claim 27, wherein the information, when accessed, results in a machine performing:
buffering a packet in a paging controller associated with at least one of a paging base station where the mobile node last entered the idle state or a paging base station where the mobile node last performed a location update; and
routing the packet buffered in the paging controller to the mobile node using an MPC to establish the routing, the MPC located within a paging group associated with a paging base station where the mobile node last exited the idle state.
